(19) United States
(12) Patent Application Publication
(10) Pub. No.: US 2012/0325840 A1
(43) Pub. Date: Dec. 27, 2012

(54) Invertible Dispenser for Pizza Boxes of Multiple Sizes

(76) Inventor: Rusty A. Restaino, Yonkers, NY (US)

(21) Appl. No.: 13/454,936

(22) Filed: Apr. 24, 2012

Related U.S. Application Data
(63) Continuation-in-part of application No. 13/166,154, filed on Jun. 22, 2011.

(51) Int. Cl. B65G 59/06; B65D 83/00

(52) U.S. Cl. 221/279; 221/282

(57) ABSTRACT

A stacker, dispenser, and carrier for pizza boxes has a rectangular parallelepiped formed with a front opening for withdrawing boxes and a rear opening for temporarily sliding the lowermost box off stops on which the stack is mounted. The lowermost box can be pushed rearward through the opening, have its front lowered, and than be withdrawn through the frontal opening of the box. A resilient band across the rear opening allows passage of the lowermost box therethrough only in response to pressure exerted during removal of the lowermost box from the stack.

### BACKGROUND OF THE INVENTION

It is a common sight at pizzerias to see pizza boxes stacked on a counter in a work area near a pizza oven. Before removing a pizza from the oven, the pizza man withdraws a box from the stack, opens it up, and then places a hot pizza inside the box.

As many as 40 or more boxes may be placed on a stack. Pulling one out from or near the bottom of the stack can be difficult in that the weight of the boxes on top of the one being withdrawn causes substantial friction between the upper surface of the box to be withdrawn and lower surface of the box above it. Moreover, as boxes are withdrawn the stack can be jostled resulting in the stack becoming misaligned and possibly falling over.

Various attempts to facilitate the removal of pizza boxes from a stack have resulted in apparatuses which are complicated and expensive to construct and/or which do not solve the problem of reducing friction between the boxes. For example, U.S. Patent Application Publication No. 2008/0224577 by Whitty for an Apparatus for Storing and Dispensing a Plurality of Boxes discloses a rectangular cage which is open at the top to receive pizza boxes to be stacked on the floor of the dispenser. A stack of boxes may also be inserted by opening a front door of the cage which has a bottom that is raised from the floor of the cage to provide a slot through which pizza boxes can be removed by pulling them forward. An optional guide wall urges the boxes forward through the slot.

U.S. Pat. No. 5,328,258 to Scalise for a Pizza Box Storage and Dispensing Assembly describes a rectangular stacker with two telescoping sections for varying the height of the device. Springs are used to grasp the pizza boxes and keep their weight off of the bottom box so that it can be easily withdrawn. Vertical corner sections project inwardly to prevent all but the lowermost of the boxes from moving forwardly and extend short of the bottom of the assembly for providing a widened slot through which the lowermost box can be removed. The height of the stack can be determined by viewing the boxes through the opening between the corner sections. A downwardly inclined plate facilitates removal of the boxes through the slot.

A basic dispenser for flat rectangular boxes which are pulled from the bottom of a stack through a horizontal opening is the subject of U.S. Pat. No. 1,986,101 to Brodsky. Brodsky teaches that the dispenser can be made by folding a sheet of cardboard having score lines to define the panels of the dispenser.

U.S. Patent Application Publication No. 2004/0188365 by Forte discloses a stacker that can handle a single stack of pizza boxes or multiple stacks side-by-side. The device has rear and side walls with an open front for containing the boxes while permitting the height of the stack to be viewed. There is an enlarged horizontal opening at the bottom for enabling withdrawal of the lowermost box from the stack.

U.S. Pat. No. 3,301,388 to Rockwell discloses a Playing Card Dispenser having a stand or frame for supporting a rectangular cartridge filled with boxes of playing cards. The cartridge has a delivery opening at its bottom for removing the lowest box in the stack. The side walls are notched to allow the box to be grasped. Rockwell also teaches that his dispenser can be made by folding a sheet of cardboard having score lines to define the panels of the dispenser.

U.S. Pat. No. 4,769,573 to Celik for a Tape Cassette Dispenser features a transparent rectangular enclosure with a horizontal inwardly notched slot at the bottom of the front wall through which the lowest tape cassette in a stack can be extracted. A similar tape dispenser is disclosed in U.S. Pat. No. 5,515,999 to Jo for an Audio Cassette Displayer and Dispenser.

U.S. Pat. No. 4,597,614 to Alexander for a Storage Dispenser Rack for Rectangular Articles discloses a container with multiple openings at differing heights through which stacked video cassettes and other rectangular articles can be withdrawn.

None of the above patents discloses a dispenser as simple and cost effective as the one of the present invention. In addition to being used as a stacker and dispenser, the container of the present invention also serves as a carrier. When formed from a lightweight material such as corrugated cardboard, one of the panels of the container can be grasped in one hand at the top and carried from one place to another while front and rear supports keep the pizza boxes securely within the container.

### SUMMARY OF THE INVENTION

A container has the general form of a hollow parallelepiped for facilitating removal of the a box from a stack of boxes contained therein. The front panel of the container has a bottom end with a lower opening and a with a width and height greater than the width and height of a box and an upper opening contiguous with the lower opening and having a width less than the width of a box.

At least one front support mounted on an inside surface of the container proximate the front panel and distal from the rear panel, has an upward facing surface in a plane transverse to the front panel and intersecting the upper opening.

A rear opening in the rear panel of the container has a width and height greater than the width and height of a box. The lowermost box of a stack of boxes within the container supported on the front support can be dispensed from the container by pushing the lowermost box rearwardly partially through the rear opening and off of the front support, lowering the front of the box below the front support thereby tilting the lowermost box away from the box in the stack immediately above the lowermost box, and then removing the lowermost box from the stack by pulling the lowermost box forward through the lower opening.

A pair of spacers project rearwardly from the rear wall for preventing interference with the partial passage of the lowermost box through the rear opening by an interfering external surface. Each of the spacers is formed from a portion of the rear wall in a margin between the rear opening and the intersection of the rear wall with an adjacent one of the side walls which has been folded back into a plane substantially transverse to the rear wall.

A resilient band obstructing the rear opening yields to pressure for allowing a rear edge of the lowermost box to partially pass through the rear opening in response to pressure exerted on the lowermost box in a rearward direction. The elastic band has ends which penetrate respective adjacent ones of the side walls or spacers and are fastened to the respective outer surfaces of the container.

The container can have a pusher slidable within the container in spaced relationship to the floor, and a spring disposed between the floor and the pusher for urging the boxes toward the support whereby the container may be inverted with the floor at, and the front opening adjacent, the top of the container for dispensing the boxes without dependence on gravity.

Each front support has an edge distal from the front panel a distance which depends on the size of the boxes stacked in the container.

### DESCRIPTION OF THE DRAWINGS

FIG. 1 is a perspective view of a filled pizza box stacker, dispenser and carrier in accordance with the preferred embodiment of the invention.

FIG. 2 is a rear elevation view of the apparatus of FIG. 1.

FIG. 3 is a partial perspective view showing a magnified portion of the preferred embodiment of the invention shown in FIG. 2.

FIG. 4 is a top plan view of the apparatus of FIG. 1 in an empty state.

FIGS. 5, 6 and 7 are a side sectional elevation views of the apparatus of the invention at different stages of use taken through line 4,5,6-4,5,6 of FIG. 2.

FIG. 8 is a perspective view of the apparatus of the invention in a stage of use before that shown in FIG. 7.

FIG. 9 is a partial perspective view showing a portion of the preferred embodiment of the invention.

FIG. 10 is a partial perspective view showing a portion of a first alternate preferred embodiment of the invention.

FIG. 11 is a side sectional elevation views of the apparatus of the invention with contents of a size different from that shown in FIG. 5 of the invention.

FIG. 12 is a side sectional elevation views of a further alternate embodiment of the apparatus of the invention which can be inverted for use in differing environments.

### DESCRIPTION OF THE PREFERRED EMBODIMENT

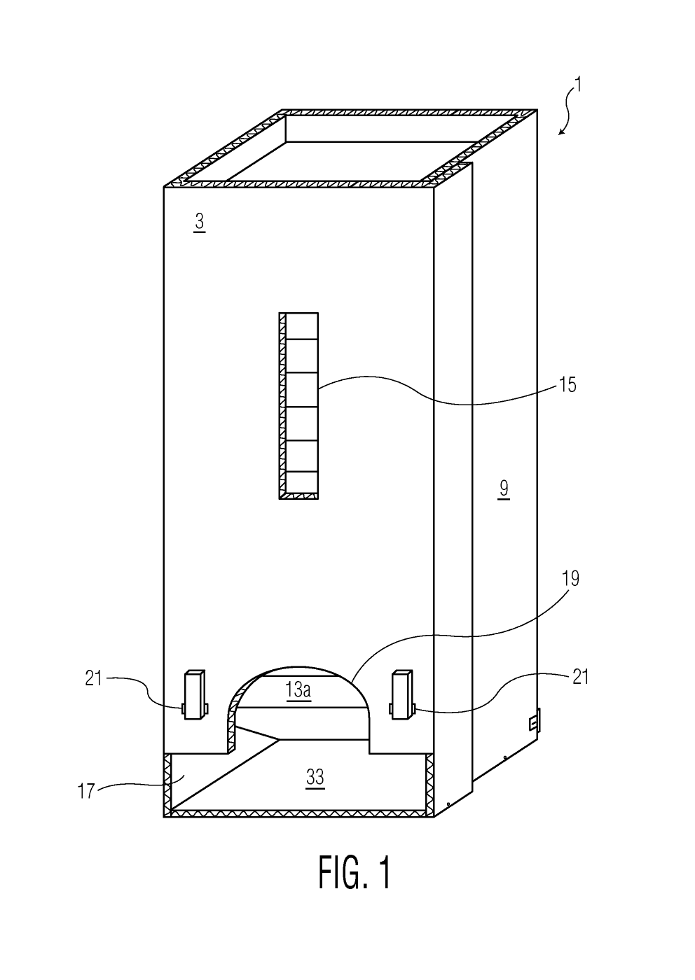

Referring now to FIGS. 1-3 of the drawings there is shown a container 1, for serving as a pizza box stacker dispenser and carrier, in the general form of a hollow upright rectangular parallelepiped having a front panel 3, a rear panel 5, a left side panel 7 and a right side panel 9. The container 1 has an open top 11 through which a stack of conventional pizza boxes 13 may be inserted. Although described for use in storing, carrying, and dispensing pizza boxes, the present invention is applicable generally to storing, carrying, and dispensing other types of boxes or other uniformly sized rectangular objects preferably having a low profile.

On the front panel 3 of the container 1 there is a centered vertical slot 15 forming a window in the panel 3 through which a portion of the stack of boxes can be seen. The window 15 provides a view from which it can be determined when it is necessary to refill the container 1 with more pizza boxes after a sufficient number have been withdrawn from the bottom of the container 1 as hereinafter explained.

At the bottom of the container 1 there is a rectangular lower opening 17 having a width slightly larger than the width of the pizza boxes intended to be stored within the container 1 and dispensed from it. Continuous with the opening 17 at the bottom of the container 1 is an upper opening 19 having a width narrower than the width of the pizza boxes 13.

The opening 19 is wide enough to enable the lowermost pizza box 13a in the container 1 to be grasped, preferably with the thumb of one hand pressing against the front edge of the box and the fingers of the same hand touching the box from below. The opening 19 preferably has a rounded top to form an arch for structural integrity and an aesthetically pleasing appearance.

On each side of the opening 19 there is inserted through a horizontal slot 21 in the front panel 3 of the container 1, a right angle bracket 25 serving as a support for the bottom of the lowermost pizza box 13a in an area proximate the front panel 3 of the container 1. Although shown as mounted on the front panel 3 of the container 1, the supports 25 can be mounted on the inside surfaces of the left side panel 7 and right side panel 9 adjacent the inside surface of the front panel 3.

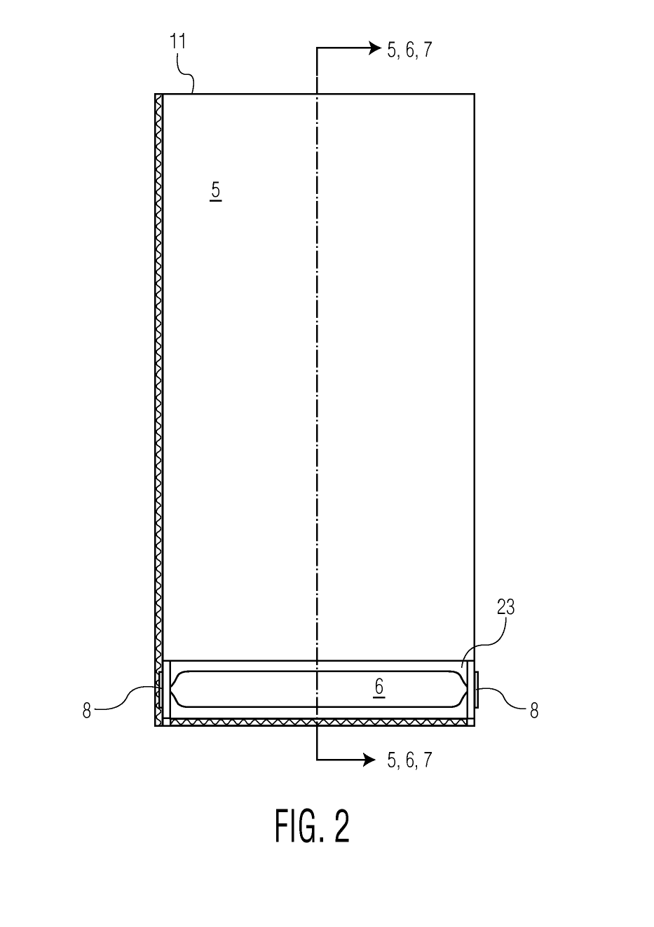

Referring now to FIG. 2 of the drawings there is shown the rear panel 5 of the container 1. Cut into the rear panel 5 of the container 1 is a rectangular opening 23 having a width slightly larger than the width of the largest sized boxes 13 and a height greater than the height of a single box 13 but less than twice the height of a box 13. Hence one box 13, and only one box 13, may be received within the rear opening 23 at a time.

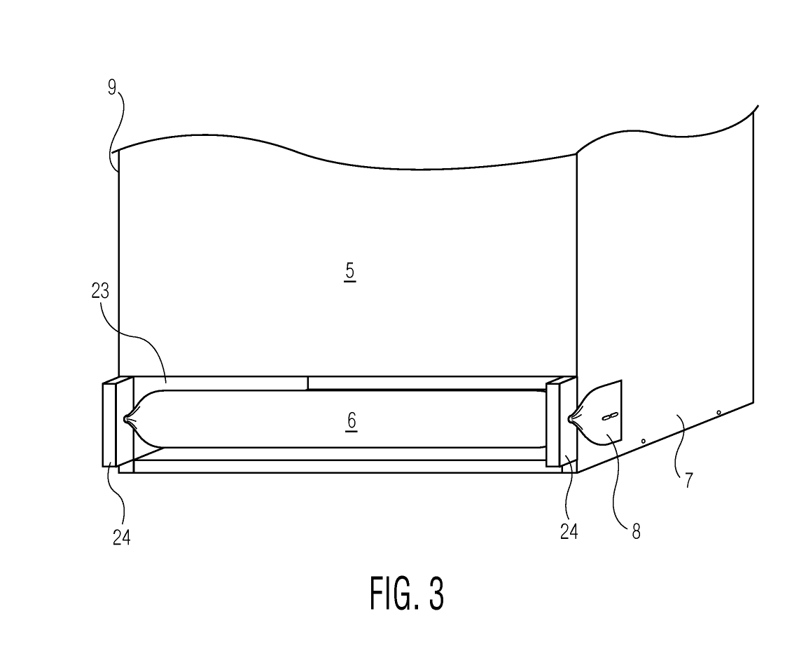

Spanning the opening 23 and preferably disposed in the plane of the rear surface of rear panel 5 is a resilient band 6 as best seen in FIG. 3.

The resilient band 6 is preferably made of an elastic material such as rubber or the like and can be a common rubber band. Alternatively, the resilient band can be formed from a strip of spring steel or the like.

The resilient band 6 serves as a barrier for normally preventing the lowermost box 13a from accidentally penetrating the rear opening 23 far enough for the front of the box 13a to recede from the supports 25 and drop to the floor 33. When the box 13a is to be withdrawn from container 1, it is pushed rearwardly through the rear opening 23 against an opposing force of the resilient band far enough for the front of the box 13a to clear the supports 25 and be lowered to an elevation whereat it can be withdrawn through the front opening 3 without obstruction.

In order to provide ample room for the lowermost box 13a to be momentarily pushed rearwardly through the opening 23, the container 1 should be spaced from the wall behind it. This can be ensured by providing one or more spacers between the rear panel 5 of the container 1 and the wall behind it. Suitable spacers 24 may be formed at the time the opening 23 is cut into the rear wall 5 of the container 1 as follows.

A centered rectangular panel slightly narrower than the width of the container 1 is cut out of the rear wall 5. The distance between each side edge of the rear opening and its adjacent wall determines the depth of the corresponding spacer to be formed. That is, each of the margins between the rear opening 23 and respective side wall 7,9 is cut or scored along parallel horizontal lines which are extensions of the top and bottom edges of the rear opening 23. The margins may then be folded ninety degrees to project rearwardly from the rear surface 5 of the container 1. For increased rigidity, the margins may be folded over on themselves and fastened to themselves by glue, tacking or any other appropriate fastening device. In the latter case, the container 1 should be wide enough relative to the widest size of box to be stacked therein to allow a rear opening wider than the width of the widest size box and margins between the opening 23 and side panels 7,9 to permit folded spacers of sufficient depth.

The ends 8,8 of the resilient band 6 penetrate openings in the container 1 at or adjacent the intersection of the spacers 24 with the side walls 7,9. The ends 8,8 of the resilient band 6 are adhered to the outer surfaces of the side walls 7,9 by a suitable fastener such as glue, adhesive tape, thumb tacks, push pins, or the like.

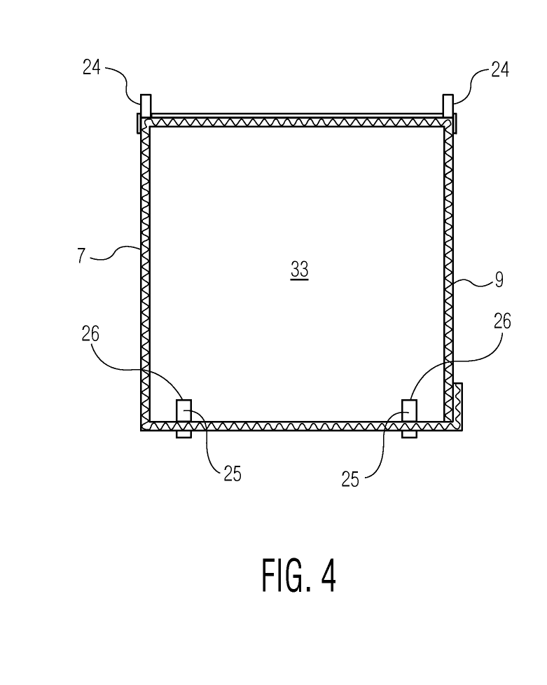

Referring to FIG. 4 of the drawings, looking down into the container 1, there can be seen the horizontal surfaces of front supports 25 formed by brackets which support the bottom of the lowermost pizza box in the stack of boxes 13 housed within the container 1. The uppermost surfaces of the horizontal portions of the brackets 25 are at an elevation greater than the bottom of the rectangular opening 23 which is in the plane of the floor 33 of the container 1 or, if the container 1 has no floor, the plane of the bottom of the container 1.

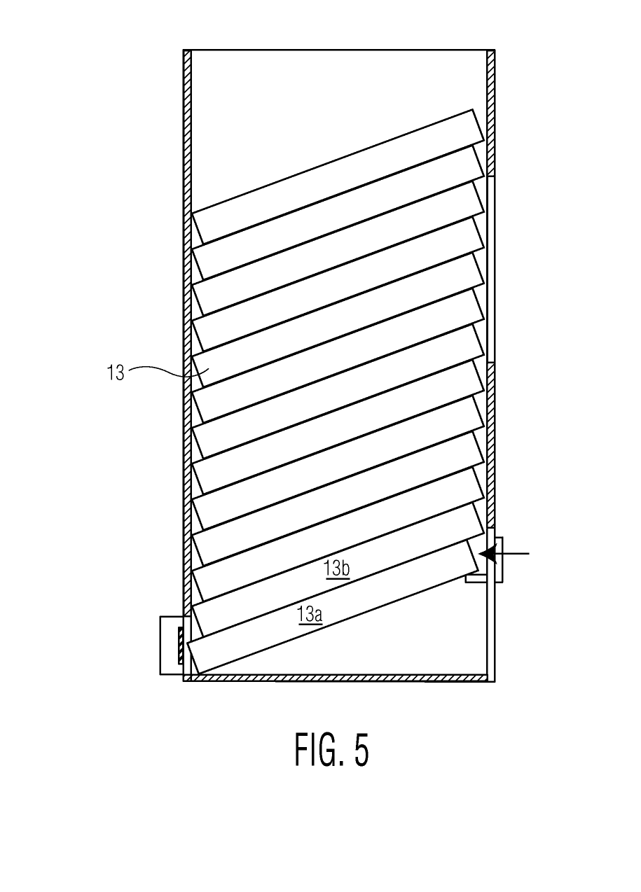

Referring now to FIG. 5 of the drawings there is shown a stack of pizza boxes 13 within a container 1 from which the lowermost box 13a is to be removed. As can be seen in FIG. 5, the lowermost box 13a has been pushed, by inserting pressure on its front panel, exposed in the upper opening 19 of the container 1, toward the rear of the container 1 thereby causing the lowermost box 13a to begin to pass through the rectangular opening 23 toward a position rearward of the supports 25 on which the front lower edge of the lowermost box 13a is still resting. At this time the area of the top surface of the lowermost box 13a within the container 1 continues to engage the bottom surface of the box 13b immediately above it, with the weight of the stack of boxes 13 causing friction between the lowermost box 13a being dispensed and the box 13b above it.

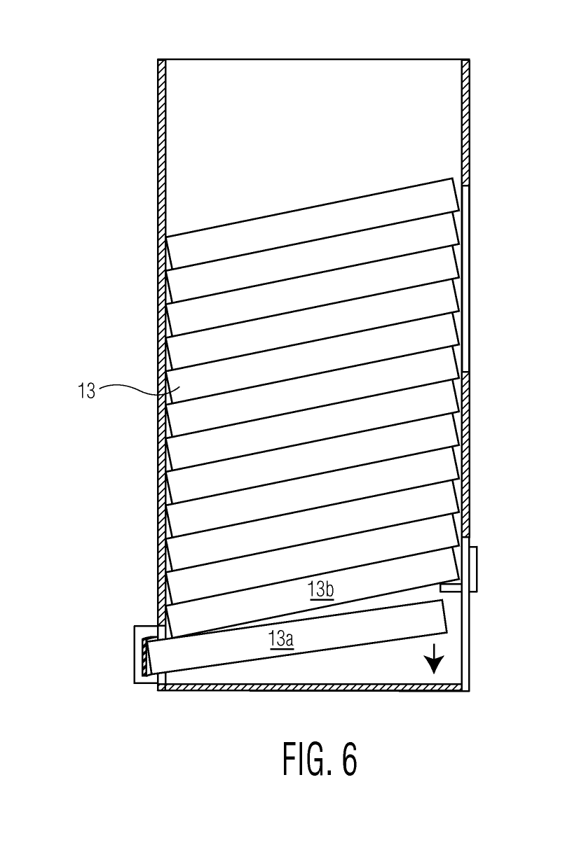

Referring now to FIG. 6, as the lowermost box 13a is pushed further rearward through the rectangular opening 23, the front of the lowermost box 13a clears the supports 25. As soon as the lowermost box 13a clears the supports 25, it is free to drop or be lowered to a position near the bottom of the container 1 in registration with the front opening 17.

As soon as the lowermost box 13a is tilted downward, it disengages the box 13b above it except for a line of engagement along the bottom rear edge of the box 13b. This greatly reduces the amount of friction between the boxes 13a and 13b and the force which must be exerted on the lowermost box 13a to withdraw it from the container 1 below the force that would have to be exerted if the lowermost box 13a were withdrawn while its entire surface area within the container 1 was in engagement with the bottom surface of the box 13b immediately above it.

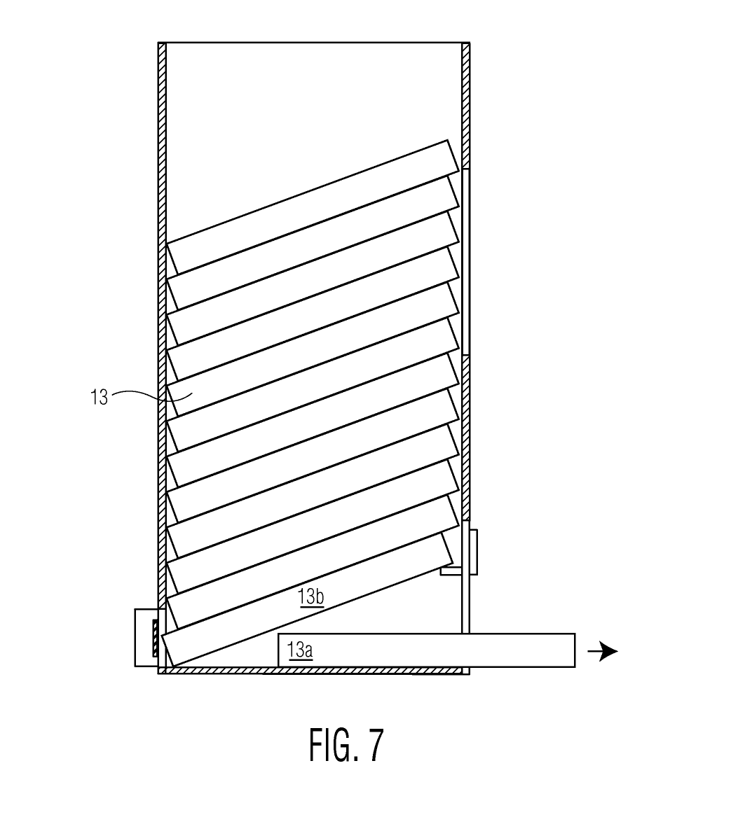

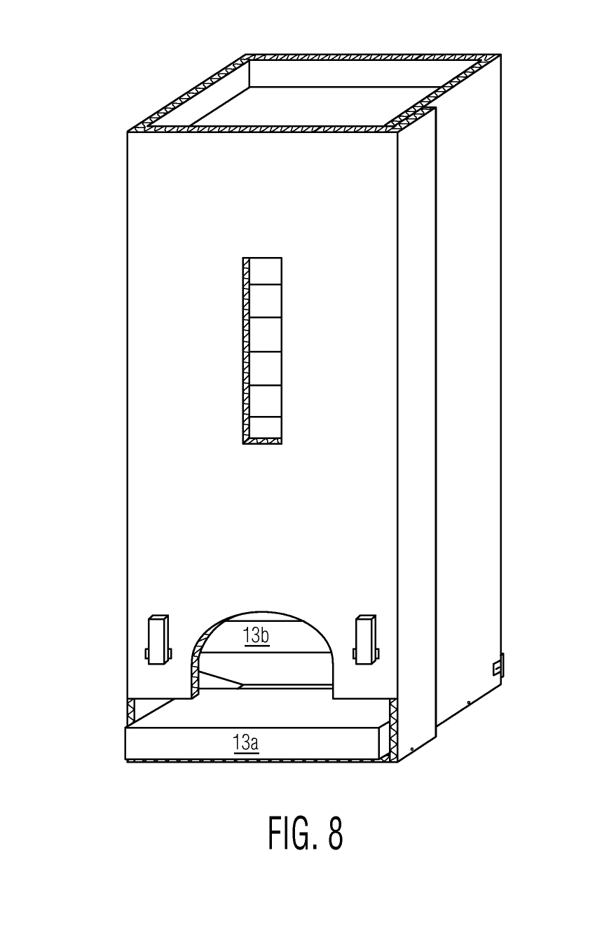

As the lowermost box 13a is withdrawn a short distance through the opening 23, the rear end of the box 13b immediately above drops until its lower rear edge meets the floor 33 as can be seen in FIGS. 7 and 8. At this time the box 13b is in a stable disposition with its front bottom edge resting on the supports 25 and rear bottom edge resting on the floor 33. Hence the box 13b can no longer move with and follow the box 13a beneath it. This desirable result enables withdrawal of the lowermost box 13a through the opening 17 to be continued free of any friction between boxes 13a and 13b. The only possible friction is between the box 13a and the floor 33 due only to the weight of the box 13a which is free of the weight of the stack above. Even this relatively small amount of friction may be alleviated if the box is lifted off the floor 33 as it is withdrawn through the opening 17.

The floor 33 of the container 1 is optional and not necessary to its dispensing function. However, the floor 33 provides a smooth surface for withdrawing the box to be dispensed with little friction and also enhances the rigidity of the container 1. Another benefit of the floor 33 is that it protects the boxes 13 from the surface of the countertop on which the container 1 is placed including any debris which may be present on the countertop.

For portability, the container 1 may be collapsed by inwardly folding adjacent panels along diagonally opposed vertical edges. If present, a floor or ceiling panel can be removed. To facilitate removal and replacement of the floor or ceiling panel, the panel(s) may be fastened in place by removable push pins (not shown) insertable from outside of the container into adjacent edges of the floor/ceiling panel(s).

The brackets 25 may be right angle brackets made from any rigid material including metal or plastic. For maximum strength, the brackets 25 can be inserted through horizontal slots 21 scored into the front panel 3 of the container 1.

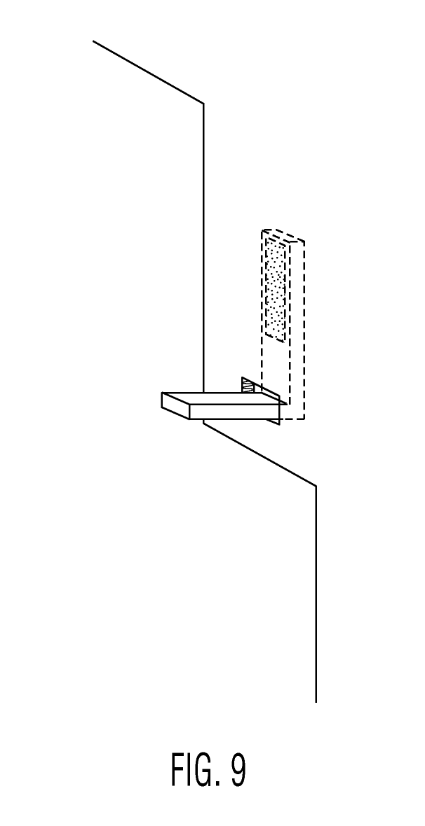

Referring additionally to FIG. 9, the inside surfaces of the vertical arms of the angle brackets 25 facing the outer surface of the front panel 3 can be coated with a pressure-sensitive adhesive covered by a peel away strip and pressed against, and thereby affixed to, the front panel 3. The horizontal arm of each angle bracket 25 rests on, and is supported by, the exposed inside edge of its respective slot 21 for stability and strength.

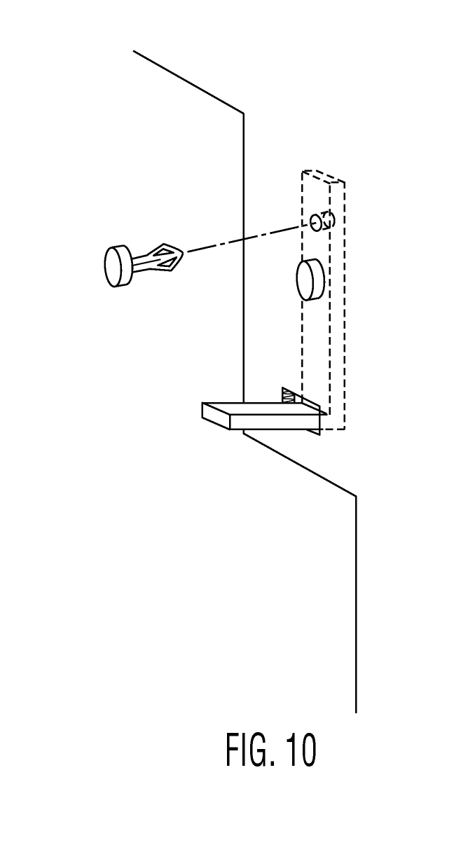

Alternatively, as shown in FIG. 10, the vertical arm of the bracket 25 can be apertured for receiving an expandable push pin fastener that can be inserted through the front panel 3 and the vertical arm from either side. Other types of conventional fasteners may employed as will be known to those skilled in the art. It is important that the portion of the fastener that extends into the interior of the container 1 not penetrate deeply enough to interfere with the downward movement of the stack of pizza boxes as each lowermost box 13a is withdrawn.

In instances where an adhesive used to affix the brackets forming the supports 25 to the panel on which the brackets are mounted is strong enough to withstand shearing forces on the inside surfaces of the container 1 due to the weight of the stacked boxes 13, the rear surfaces of the vertical arms of the brackets 25 can be adhered to the inside surface of the front panel 3 of the container 1 without forming, or inserting the brackets through, slots in the front panel 3 of the container 1. Here, too, a peel off strip can be used to expose an adhesive on the rear of the brackets' vertical arms which can then be pressed against the inside facing surface of the front panel 3.

It is to be noted that the front supports 25 can be affixed not only to the front panel of the container 1 but also to the inside surfaces of the side panels 7, 9 of the container 1 at positions adjacent to the front panel 3.

It is desirable that the inner dimensions of the container 1, that is the length and width, be only slightly larger than the length and width of the largest size pizza boxes to be stored in and dispensed from the container 1. In order to prevent jamming of the pizza boxes within the container 1, it is preferable to have each of the length and width of the inside of the container 1 exceed the outside length and width of the largest sized pizza boxes by ⅛ to one ¼ inch.

A single container 1 may accommodate stacks of pizza boxes of smaller than the largest size by employing supports having horizontal members which protrude into the container 1 by an appropriate distance in order to maintain the above stated relationship by which the front supports 25, on the one hand, and the rear wall 5, on the other hand, extend toward one another by a distance greater than the distance by which the depth of the inside of the container 1 exceeds the depth D of the pizza boxes 13.

For a container having a width W_{c} and a depth D_{c} housing a stack of boxes having a width W_{b} and a depth D_{b}, the minimum distance S of the rear edge or lip 26 of each front support 25 from the inner surface of the front panel 3 may be computed as follows.

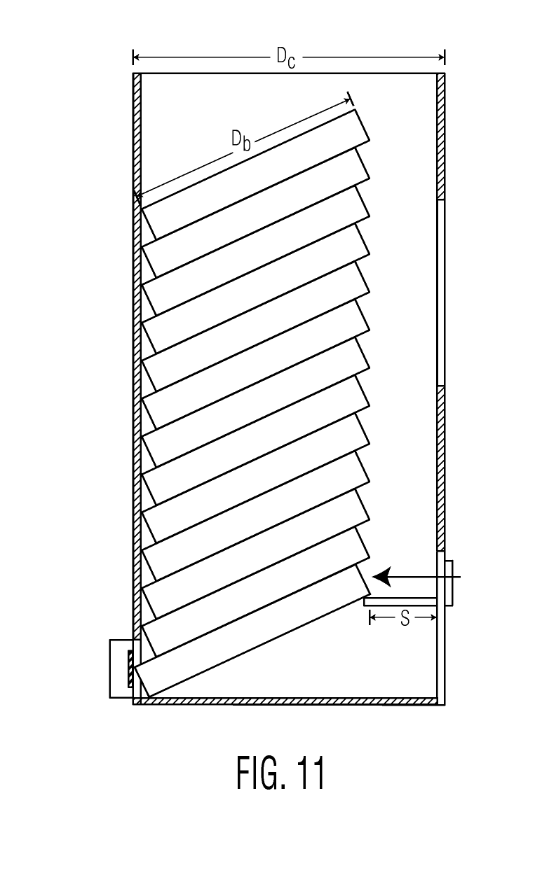

Referring to FIG. 11, for a front support having an upper surface at a elevation E above the floor 33, the

(D_{c}−S)²+H²=D_{b}²

(D_{c}−S)²=D_{b}²−H²

D_{c}−S=√(D_{b}²−H²)

S=D_{c}−√(D_{b}²−H²)

Where D_{b}>H.

Where the supports 25 are mounted on the side panels 7,9, the edges most distal from the front panel and proximate the rear panel should be a minimum of distance S from the inside surface of front panel 3.

### Example 1

Where boxes for large size pizzas are to be stacked, each having a depth D_{b} and width W_{b} of 16 inches, and a height H of two inches, and the container 1 was a depth D_{c} and width W_{c} of 16.5 inches

the following dimensions for the container 1 have been found to be desirable.

Height of front opening 17=3 inches;

Height of rear opening 23=3 inches;

Elevation of front support 25 above floor 33=5 inches

S=16.5−√(16²−5²)=1.3 inches

### Example 2

For the same container 1 as in Example 1 above, where boxes for medium size pizzas are to be stacked, each having a depth D_{b} and width W_{b} of 14 inches, and a depth D of two inches,

Height of front opening 17=3 inches;

Height of rear opening 23=3 inches;

Elevation of front support 25 above floor 33=5 inches

S=16.5−√(14²−5²)=3.4 inches

### Example 3

For the same container 1 as in Examples 1 and 2 above, where boxes for small size pizzas are to be stacked, each having a depth D_{b} and width W_{b} of 12 inches, and a depth D of two inches,

Height of front opening=3 inches;

Height of rear opening=3 inches;

Height of front support above floor 33=5 inches

S=16.5−√(12²−5²)=5.6 inches

To allow for slight variances in the dimensions of the container 1 and boxes 13, it is preferable that the actual distance of the rear lip 26 of each front support 25 from the inner surface of the front panel 3 be ½ to 1½ inches greater than S.

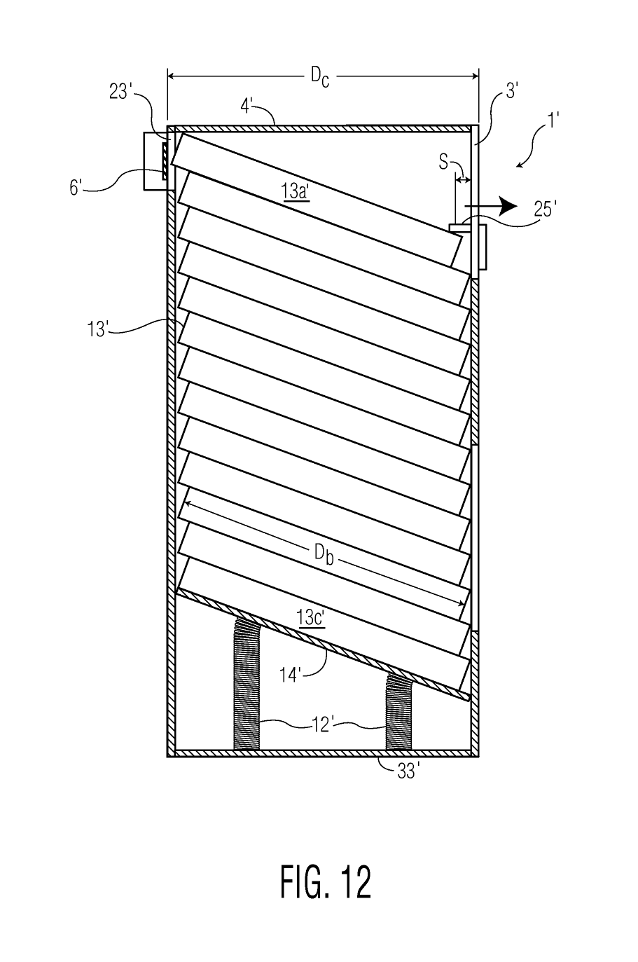

In certain environments, it may be desirable to place the container 1 under a counter or elsewhere on the floor of the establishment instead of upon an elevated countertop. In FIG. 12, there is shown an alternate embodiment of the invention in the form of container 1′ which is substantially identical to container 1 with the following differences which allow for its use in an inverted disposition whereby boxes can be dispensed from near the top of the container 1′.

Referring now to FIG. 12, a fixed panel 4′ forms a ceiling of the container 1′ and another fixed panel 33′ forms a floor of the container 1′ when container 1′ is inverted with respect to the normal orientation of container 1. The floor panel 33′ is removable or hinged along one edge so that it may be moved out of the way with the container turned over to permit boxes 13 to be inserted into container 1′ before turning the container 1′ back to the position ready for dispensing the boxes 13 as shown in FIG. 12.

Seated atop two coil springs 12′,12′ fixed to the upper surface of floor 33′ is a pusher in the form of a planar panel 14′ which is movable in a vertical direction for urging a stack of pizza boxes 13 upwardly against the force of gravity whereby the front upper surface of the topmost box 13a′ engages an undersurface of each support 25′ in the container 1′ and the rear upper surface of the topmost box 13a′ engages the ceiling panel 4′. The boxes in the stack 13′ are inverted relative to their dispositions when used on a countertop in container 1 so that when withdrawn they are in an upright position for enabling the top of each box 13a′ to lifted for opening the box 13a′ without first having to turn it to an upright position.

The springs 12′,12′ shown fully compressed when the container is filled with boxes 13 are long enough to raise the bottommost box 13c′ to a position where the front upper surface of the box 13c′ engages the undersurface of each support 25′ in the container 1′ and the rear upper surface of box 13c′ engages ceiling panel 4′. Although two coil springs have been shown in the drawings, it is possible to employ a single spring of large enough diameter, preferable at or near the center of the pusher 14′.

When the box 13a′ is to be withdrawn from container 1′, it is pushed rearwardly through the rear opening 23′ against the opposing force of the elastic band 6′ far enough for the front of the box 13a′ to clear the supports 25′ and be raised to an elevation whereat it can be withdrawn through the front opening 3′ without obstruction. Container 1′ can be employed atop a counter in a disposition like container 1 shown in FIG. 5 or on a floor in the position shown in FIG. 12 by inverting it.

It is to be appreciated that the foregoing is a description of a preferred embodiment of the invention to which alterations and modifications may be made without departing from the spirit and scope of the invention.

What is claimed is:

1. A container for facilitating removal of the a box from a stack of boxes contained therein, each of said boxes having a width W, a depth D and a height H, said container having the general form of a hollow parallelepiped,
comprising a front panel,
a rear panel,
a left side panel,
a right side panel,
said front panel having proximate a bottom end of said container a lower opening with a width greater than W and a height greater than H and an upper opening distal from said bottom end of said container and contiguous with said lower opening and having a width less than W,
at least one front support mounted on an inside surface of said container proximate said front panel and distal from said rear panel, and having an upward facing surface in a plane transverse to said front panel and intersecting said upper opening,
a rear opening in said rear panel having a width greater than W, and a height greater than H,
whereby the lowermost box of a stack of boxes within said container supported on said front support can be dispensed from said container by pushing said lowermost box rearwardly partially through said rear opening and off of said front support, lowering the front of said box below said front support thereby tilting said lowermost box away from the box in said stack immediately above said lowermost box, and then removing said lowermost box from said stack by pulling said lowermost box forward through said lower opening.

2. A container according to claim 1 wherein said container further comprises a floor and said rear opening has a bottom edge substantially flush with an upper surface of said floor.

3. A container according to claim 1 wherein said one front support is a left front support mounted between said left side panel and said upper opening, and further comprising a right front support mounted on an inside surface of said container proximate said front panel between said right side panel and said upper opening, distal from said rear panel, and having an upward facing surface in said plane

4. A container according to claim 1 wherein said container comprises a pair of spacers projecting from said rear wall for preventing interference with the partial passage of said lowermost box through said rear opening by an interfering external surface.

5. A container according to claim 4 wherein said each of said spacers comprises a portion of said rear wall in a margin between said rear opening and the intersection of said rear wall with an adjacent one of said side walls which has been folded back into a plane substantially transverse to said rear wall.

6. A container according to claim 1 further comprising a resilient band obstructing said rear opening, said resilient band yielding to pressure for allowing a rear edge of said lowermost box to partially pass through said rear opening in response to pressure exerted on said lowermost box in a rearward direction.

7. A container according to claim 6 wherein said elastic band has ends which penetrate respective adjacent ones of said side walls and are fastened to said respective outer surfaces of said container.

8. A container according to claim 6 wherein said elastic band has ends which penetrate respective adjacent ones of said spacers and are fastened to respective outer surfaces of said container.

9. A container according to claim 2 further comprising
a pusher slidable within said container in spaced relationship to said floor, and
a spring disposed between said floor and said pusher for urging said boxes toward said support whereby said container may be inverted with said floor at, and said front opening adjacent, the top of said container for dispensing said boxes without dependence on gravity.

10. Apparatus for packaging an item comprising,
a container having a front panel, a rear panel, a left side panel, and a right side panel,
a plurality of identical boxes stacked within said container, each of said boxes having a width W_{b}, a depth D_{b} and a height H, said container having the general form of a hollow parallelepiped with an interior chamber having a width W_{c} and a depth D_{c}, said front panel having proximate a bottom end of said container a lower opening with a width greater than W_{b} and a height greater than H and an upper opening distal from said bottom end of said container and contiguous with said lower opening and having a width less than W_{b},
at least one front support mounted on an inside surface of said container proximate said front panel and distal from said rear panel, and having an upward facing surface in a plane transverse to said front panel and intersecting said upper opening, said support having an edge distal from said front panel a distance of at least S where S=S=D_{c}−√(D_{b}²−H²) and D_{b}>H.
whereby the lowermost box of a stack of boxes within said container supported on said front support can be dispensed from said container by pushing said lowermost box rearwardly partially through said rear opening and off of said front support, lowering the front of said box below said front support thereby tilting said lowermost box away from the box in said stack immediately above said lowermost box, and then removing said lowermost box from said stack by pulling said lowermost box forward through said lower opening.

11. Apparatus according to claim 10 wherein the distance of said support edge from said front panel is in the range of S+½ inch to S+1½ inches.
